(19) United States
(12) Patent Application Publication
(10) Pub. No.: US 2008/0279070 A1
(43) Pub. Date: Nov. 13, 2008

(54) Optical Data Storage System and Method of Optical Recording and/or Reading

(75) Inventors: Ferry Zijp, Eindhoven (NL); Marcello Leonardo Mario Balistreri, Eindhoven (NL); Martinus Bernardus Van Der Mark, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/599,992

(22) PCT Filed: Apr. 15, 2005
(86) PCT No.: PCT/IB05/51243

§ 371 Date: Oct. 17, 2006

(30) Foreign Application Priority Data
Apr. 20, 2004 (EP) 04101634.6

(51) Int. Cl. G11B 5/58; G11B 7/00

(52) U.S. Cl. 369/53.17; 369/112.24

(57) ABSTRACT

An optical data storage system for recording and/or reading, using a radiation beam, having a wavelength λ, focused onto a data storage layer of an optical data storage medium is described. The system comprises the medium having a cover layer that is transparent to the focused radiation beam, an optical head, including an objective having a numerical aperture NA, said objective including a solid immersion lens that is adapted for being present at a free working distance of smaller than λ/10 from an outermost surface of said medium. The optical head comprises a first adjustable optical element corresponding to the solid immersion lens, means for axially moving the first optical element and dynamically keeping constant the distance between cover layer and solid immersion tens, a second adjustable optical element, means for dynamically adjusting the second optical element for changing the focal position of the focal point of the focused radiation beam relative to an exit surface of the solid immersion lens. This achieves reliable read-out and writing during cover layer thickness variations. Further a method is described for controlling such a system.

The invention relates to an optical data storage system for recording and/or reading, using a radiation beam, having a wavelength λ, focused onto a data storage layer of an optical data storage medium, said system comprising:

the medium having a cover layer that is transparent to the focused radiation beam,

an optical head, including an objective having a numerical aperture NA, said objective including a solid immersion lens that is adapted for being present at a free working distance of smaller than λ/10 from an outermost surface of said medium and arranged on the cover layer side of said optical data storage medium, and from which solid immersion lens the focused radiation beam is coupled by evanescent wave coupling into the cover layer of the optical data storage medium during recording/reading.

The invention further relates to a method of optical recording and/or reading with such a system.

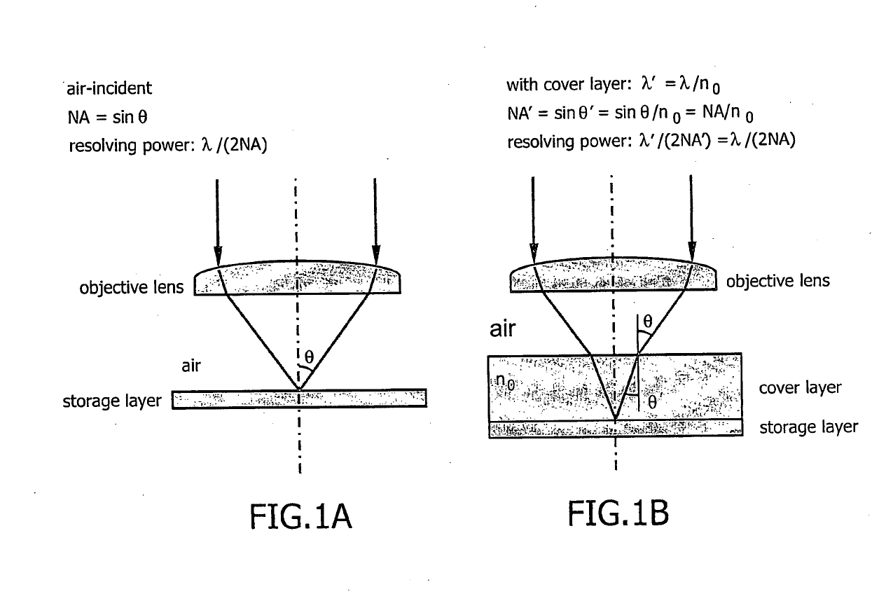

A typical measure for the focussed spot size or optical resolution in optical recording systems is given by r=λ/(2NA), where λ is the wavelength in air and the numerical aperture of the lens is defined as NA=sin θ. In FIG. 1A, an air-incident configuration is drawn in which the data storage layer is at the surface of the data storage medium: so-called first-surface data storage. In FIG. 1B, a cover layer with refractive index n protects the data storage layer from a.o. scratches and dust.

From these figures it is inferred that the optical resolution is unchanged if a cover layer is applied on top of the data storage layer: On the one hand, in the cover layer, the internal opening angle θ′ is smaller and hence the internal numerical aperture NA′ is reduced, but also the wavelength in the medium λ′ is shorter by the same factor n₀. It is desirable to have a high optical resolution because the higher the optical resolution, the more data can be stored on the same area of the medium. Straight forward methods of increasing the optical resolution involve widening of the focused beam opening angle at the cost of lens complexity, narrowing of allowable disk tilt margins, etc. or reduction of the in-air wavelength i.e. changing the colour of the scanning laser.

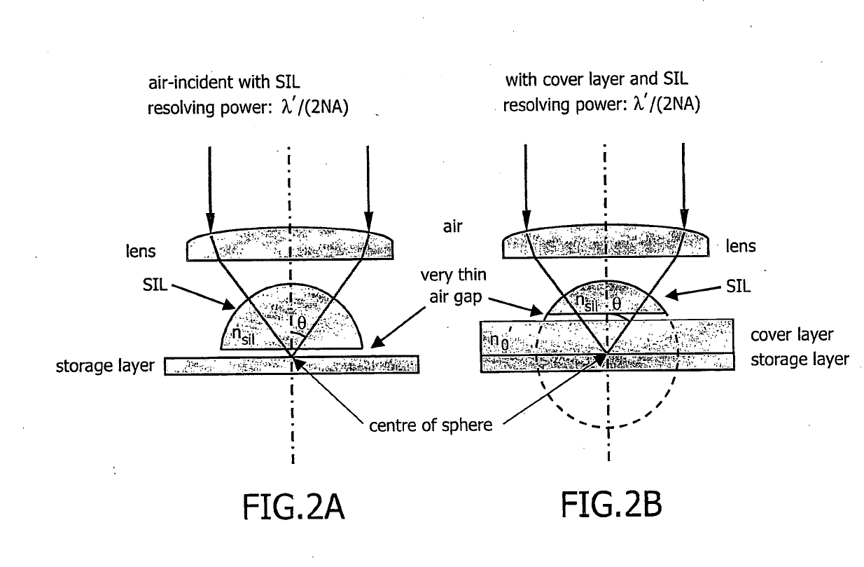

Another proposed method of reducing the focussed spot size in an optical disk system involves the use of a solid immersion lens (SIL). In its simplest form, the SIL is a half sphere centred on the data storage layer, see FIG. 2A, so that the focussed spot is on the interface between SIL and data layer. In combination with a cover layer of the same refractive index, n₀′=n_{SIL}, the SIL is a tangentially cut section of a sphere which is placed on the cover layer with its (virtual) centre again placed on the storage layer, see FIG. 2B. The principle of operation of the SIL is that it reduces the wavelength at the storage layer by a factor n_{SIL}, the refractive index of the SIL, without changing the opening angle θ. The reason is that refraction of light at the SIL is absent since all light enters at right angles to the SIL's surface (compare FIG. 1B and FIG. 2A).

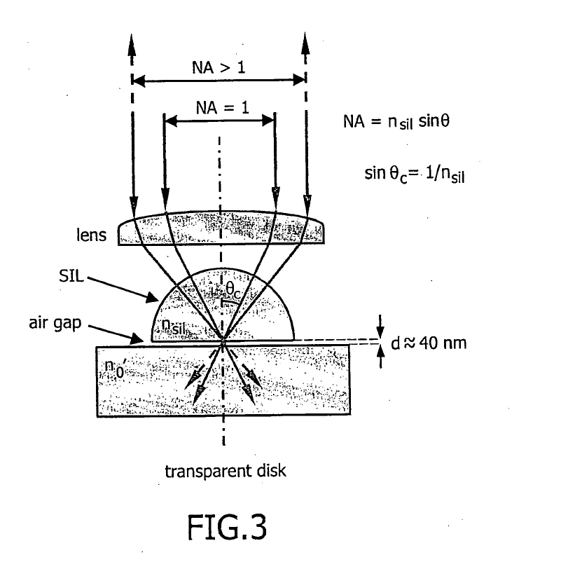

Very important, but not mentioned up until this point, is that there is a very thin air gap between SIL and recording medium. This is to allow for free rotation of the recording disk with respect to the recorder objective (lens plus SIL). This air gap should be much smaller than an optical wavelength (typically it should be smaller than λ/10) such that so-called evanescent coupling of the light in the SIL to the disc is still possible. The range over which this happens is called the near-field regime. Out side this regime, at larger air gaps, total internal reflection will trap the light inside the SIL and sent it back up to the laser. Note that in case of the configuration with cover layer as depicted in FIG. 2B, that for proper coupling the refractive index of the cover layer should be at least equal to the refractive index of the SIL, see FIG. 3 for further details.

Waves below the critical angle propagate through the air gap without decay, whereas those above the critical angle become evanescent in the air gap and show exponential decay with the gap width (see FIG. 3). At the critical angle NA=1. For large gap width all light above the critical angle reflects from the proximate surface of the SIL by total internal reflection (TIR).

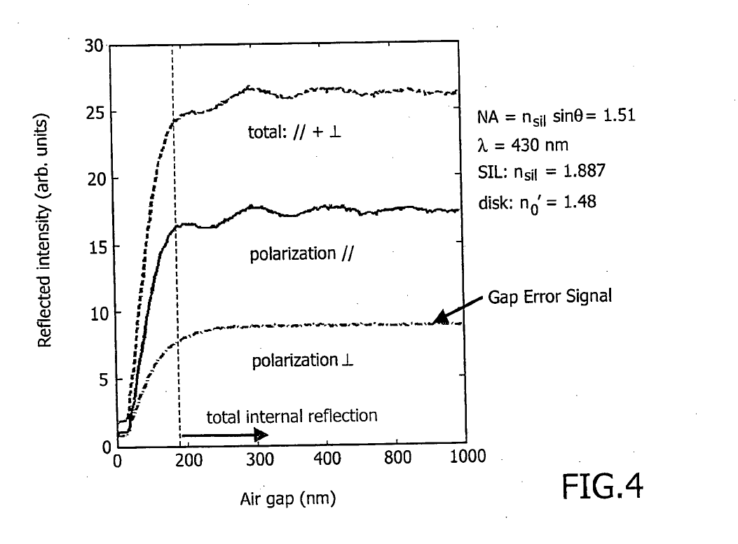

For a wavelength of 405 nm, which wavelength is also used for the Blu-ray optical Disc (BD), the maximum air-gap is approximately 40 nm, which is a very small free working distance (FWD) as compared to conventional optical recording. The near-field air gap between data layer and the solid immersion lens (SIL) should be kept constant within 5 nm or less in order to get sufficiently stable evanescent coupling. In hard disk recording, a slider-based solution relying on a passive air bearing is used to maintain this small air gap. In optical recording, where the recording medium must be removable from the drive, the contamination level of the disk is larger and will require an active, actuator-based solution to control the air gap. To this end, a gap error signal (GES) must be extracted, preferably from the optical data signal already reflected by the optical medium. Such a signal can be found, and a typical gap error signal is given in FIG. 4. Note that it is common practice in case a near-field SIL is used to define the numerical aperture as NA=n_{SIL} sin θ, which can be larger than 1.

FIG. 4 shows a measurement (taken from Ref. [1]) of the amounts of reflected light for both the parallel and perpendicular polarisation states with respect to the linearly polarised collimated input beam from a flat and transparent optical surface (“disc”) with a refractive index of 1.48. These measurements are in good agreement with theory. The evanescent coupling becomes perceptible below 200 nm (the light vanishes in to the “disc”) and the total reflection drops almost linearly to a minimum at contact. This linear signal may be used as an error signal for a closed loop servo system of the air gap. The oscillations in the horizontal polarisation are caused by the reduction of the number of fringes within NA=1 with decreasing gap thickness.

More details about a typical near-field optical disc system can be found in Ref. [2].

A root problem for optical recorder objectives, either slider-based or actuator-based, having a small working distance, typically less than 50 μm, is contamination of the optical surface closest to the storage medium occurs. This is due to re-condensation of water, which may be desorbed from the storage medium because of the high surface temperature (typically 250° C. for Magneto Optical (MO) recording and 650° C. for Phase Change (PC) recording) resulting from the high laser power and temperature required for writing data in, or even reading data from, the data recording layer. The contamination ultimately results in malfunctioning of the optical data storage system due to runaway of, for example, the servo control signals of the focus and tracking system. This problem is a.o. described in the patent application publications and patents given in Refs. [3]-[5].

The problem becomes more severe for the following cases: high humidity, high laser power, low optical reflectivity of the storage medium, low thermal conductivity of the storage medium, small working distance and high surface temperature.

A known solution to the problem is to shield the proximal optical surface of the recorder objective from the data layer by a thermally insulating cover layer on the storage medium. An invention based on this insight is for example given in Ref. [4].

Obviously, putting a cover layer on the near-field optical storage medium has the additional advantage that dirt and scratches can no longer directly influence the data layer.

However, by putting a cover layer onto a near-field optical system, new problems arise, which lead to new measures to be taken.

Normally, the accuracy by which the near-field air gap between data layer and the solid immersion lens (SIL) should be kept constant within 5 nm or less in order to get sufficiently stable evanescent coupling. In case a cover layer is used, the air gap is between cover layer and SIL, see FIG. 2B. Again, the air gap should be kept constant to within 5 nm. Clearly, the STL focal length should have an offset to compensate for the cover layer thickness, such as to guarantee that the data layer is in focus at all times. Note that the refractive index of the cover layer, if it is lower than the refractive index of the SIL, determines the maximum possible numerical aperture of the system.

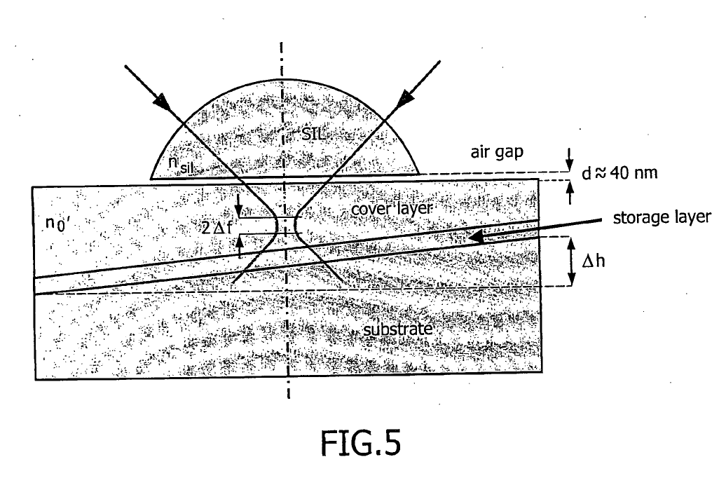

In order to obtain sufficient thermal isolation, the dielectric cover layer thickness should be more than approximately 0.5 μm, but preferably is of the order of 2-10 μm. Taken together this means that by controlling the width of the air gap only, the thickness variation of the cover layer Ah should be (much) smaller than the focal depth Δf=λ/(2NA²) in order to guarantee that the data layer is in focus: Δh<Δf, see FIG. 5. If we take the wavelength λ=405 nm and numerical aperture NA=1.45 we find that Δf=50 nm. For spin-coated layers of several microns thickness this means less than a percent of thickness variation over the entire data area of the disc, which seems a challenging accuracy.

It is an object of the invention to provide an optical data storage system for recording and/or reading of the type mentioned in the opening paragraph, in which reliable data recording and read out is achieved using a near-field solid immersion lens in combination with a cover layer. It is an further object to provide a method of optical recording and/or reading for such a system.

This object has been achieved in accordance with the invention by an optical data storage system, which is characterized in that the optical head comprises:

a first adjustable optical element corresponding to the solid immersion lens,

means for axially moving the first optical element and dynamically keeping constant the distance between cover layer and solid immersion lens,

a second adjustable optical element,

means for dynamically adjusting the second optical element for changing the focal position of the focal point of the focused radiation beam relative to an exit surface of the solid immersion lens.

Given that the cover layer does not have sufficiently small thickness variation Δh, say its thickness varies by more than 50-100 nm, we propose a dynamic correction of focal length to compensate for cover layer thickness variations, in addition to the dynamic air gap correction.

The purpose is that the data layer is in focus and at the same time the air gap between SIL and cover layer is kept constant so that proper evanescent coupling is guaranteed. Keeping constant means not more variation in air gap than 5 nm, preferably 2 mm.

The optical lightpath should contain at least two adjustable optical elements. An adjustable optical element could for example be part of either the collimator lens or the objective.

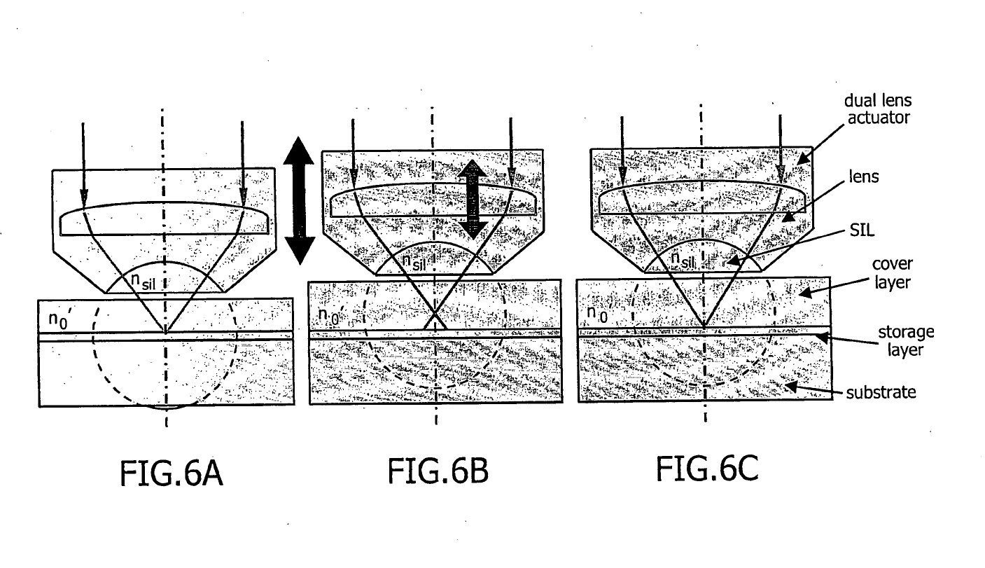

For example, an objective lens comprising two elements which can be axially displaced to adjust the focal length of the pair without substantially changing the air gap. The air gap can then be adjusted by moving the objective as a whole, see FIG. 6. In general, a certain amount of spherical aberration will remain. In some cases, optimum design of the lens system and cover layer combination will meet the system requirements, in other cases active adjustment of spherical aberration will be required and Luther measures will have to be taken.

In an embodiment the second optical element is present in the objective.

In another embodiment the second optical element is present outside the objective.

The second optical element may e.g. be axially movable with respect to the first optical element. Alternatively the second optical element has a focal length which is electrically adjustable, e.g. by electrowetting or electrically influencing the orientation of liquid crystal material.

The further object has been achieved in accordance with the invention by a method of optical recording and reading with a system as described above, wherein:

the free working distance is kept constant by using a first, relatively high bandwidth servo loop based on a gap error signal, e.g. derived from the amount of evanescent coupling between the solid immersion lens and the cover layer,

the first optical element is actuated based on the first servo loop,

a second, relatively high bandwidth servo loop is active based on a focus control,

the second optical element is adjusted based on the second servo loop in order to retrieve an optimal modulated signal. By relatively high bandwidth is meant a normal optical recording focus servo bandwidth, e.g. several kHz.

In an embodiment an oscillation is superimposed on the adjustment of the second optical element and wherein the focus control signal additionally is derived from the oscillation direction of the second optical element and from the modulation depth of a modulated signal recorded in the data storage layer. When the focus servo is derived from the modulation depth of a modulated signal recorded in the data storage layer a small continuous oscillation of the focal depth, i.e. a periodic modulation super imposed on the focus adjustment signal, is needed. Small means of the order of a focal depth. This is in order to determine in which direction the servo should be adjusted for finding the maximum modulation depth. In other words e.g. the focal position is oscillated and the polarity of the focus control signal is derived from both the modulation depth of a modulated signal recorded in the data storage layer and the oscillation direction of the focal position.

In an embodiment the modulated signal is present as pre-recorded data in the optical data storage medium, e.g. in a lead-in area of the optical data storage medium;

In another embodiment the modulated signal is present as a wobbled track of the optical data storage medium.

In another embodiment the focus control signal is derived from an S-curve type focus error signal.

The invention will now be explained in more detail with reference to the drawings in which

FIGS. 1A and 1B show a normal far-field optical recording objective and data storage disk resp. without and with cover layer,

FIGS. 2A and 2B show a Near-Field optical recording objective and data storage disk resp. without and with cover layer,

FIG. 3 shows that total internal reflection occurs for NA>1 if the air gap is too wide,

FIG. 4 shows a measurement of the total amount of the reflected light for the polarisation states parallel and perpendicular to the polarisation state of the irradiating beam, and the sum of both,

FIG. 5 shows that the thickness variation of the cover layer may be larger or smaller than the focal depth,

FIGS. 6A, 6B and 6C show the principle of operation of a dual actuator in case of varying cover layer thickness,

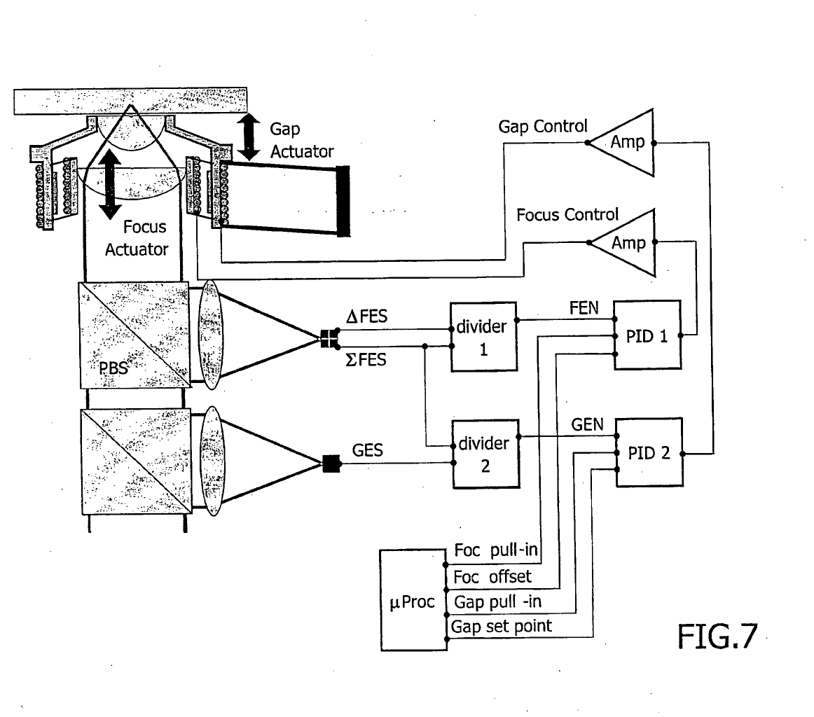

FIG. 7 shows a block diagram of the double servo required to drive the dual lens actuator,

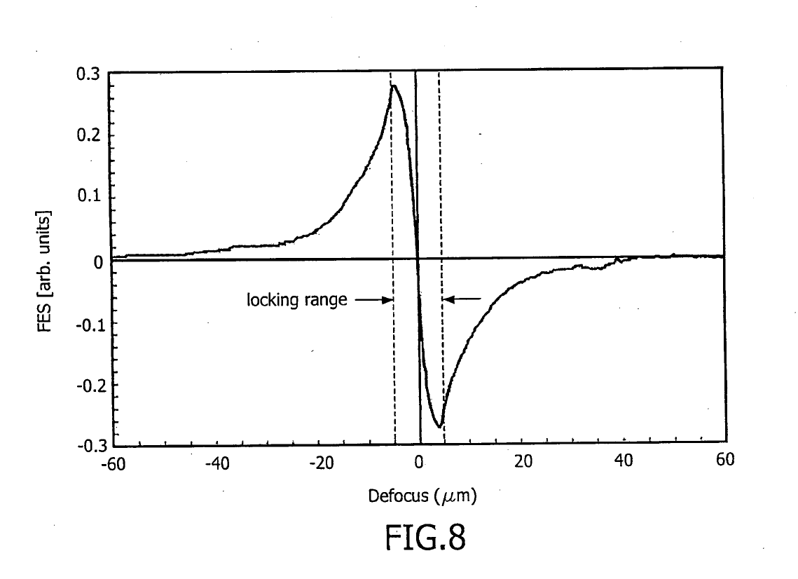

FIG. 8 shows an example of a conventional S-curve type focus error signal (FES),

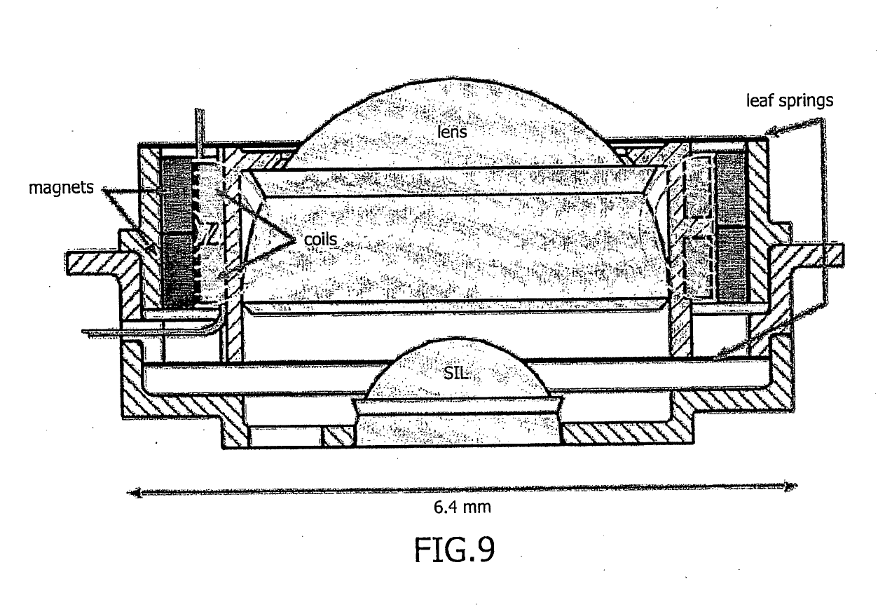

FIG. 9 shows a cross section of a possible embodiment of a dual lens actuator for near field,

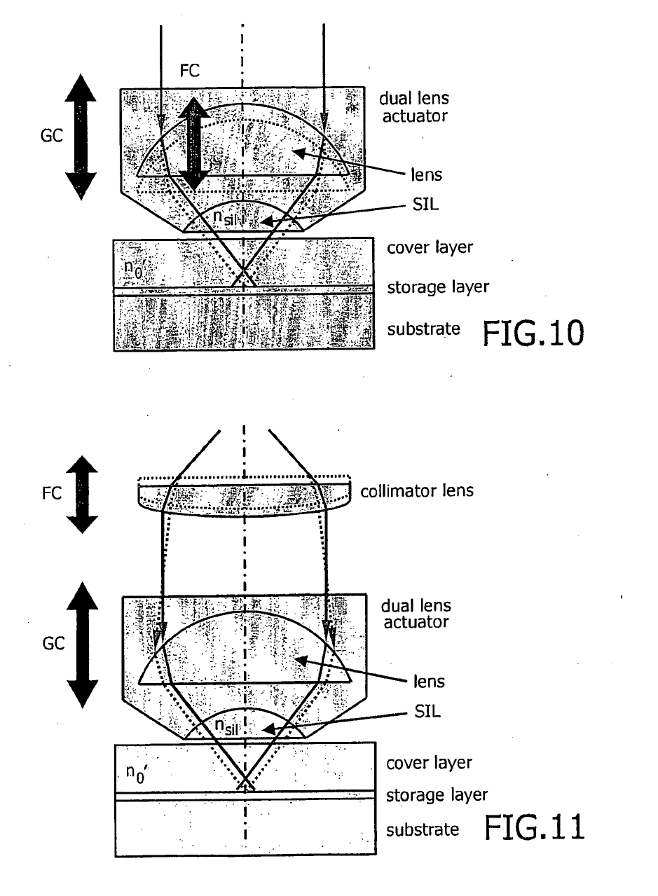

FIG. 10 shows that defocus can be obtained by moving the lens with respect to the SIL using the Focus Control (FC). The air gap is kept constant using the Gap Control (GC),

FIG. 11 shows that defocus also can be obtained by moving the laser collimator lens with respect to the objective,

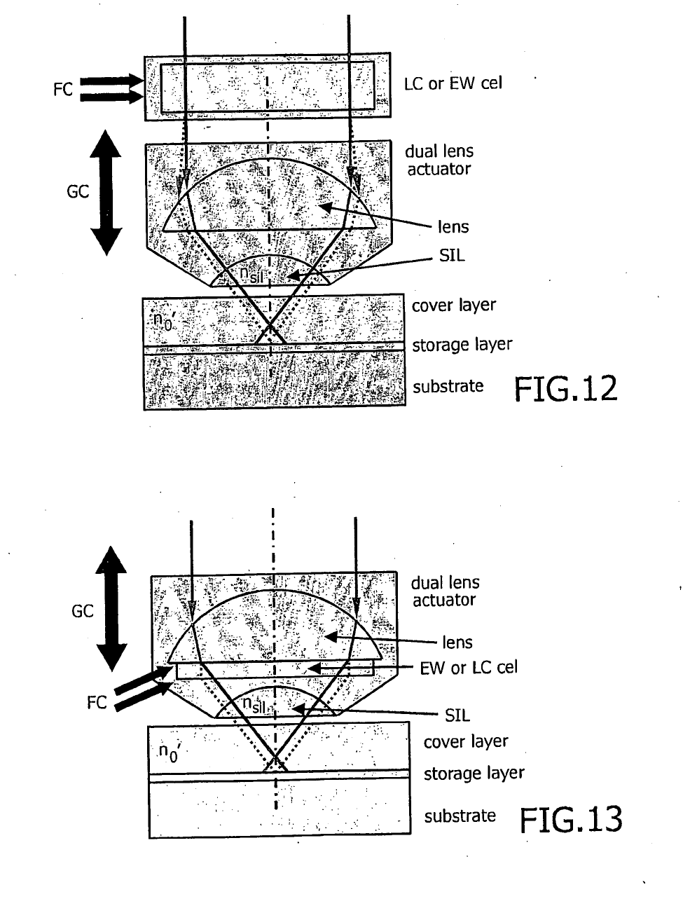

FIG. 12 shows an embodiment of a dual lens actuator wherein a switchable optical element based on electrowetting (EW) or liquid crystal (LC) material can be used to adjust the focal length of the optical system, and

FIG. 13 shows another embodiment as in FIG. 12 wherein the switchable optical element is placed between the first lens and the SIL.

In FIGS. 1A and 1B a normal far-field optical recording objective and data storage disk resp. without cover layer and with cover layer are shown.

In FIGS. 2A and 2B a Near-Field optical recording objective and data storage disk resp. without and with cover layer are shown. The effective wavelength is reduced to λ′=λ/n_{SIL}. The effective wavelength is reduced to λ′=λ/n₀′. The width of the air gap is typically 25-40 nm (but at least less than 100 nm), and is not drawn to scale. The thickness of the cover layer typically is several microns but is also not drawn to scale.

In FIG. 3 is shown that total internal reflection occurs for NA>1 if the air gap is too wide. If the air gap is thin enough, the evanescent waves make it to the other side and in the transparent disk become propagating again. Note that if the refractive index of the transparent disk is smaller than the numerical aperture, n₀′<NA, that some waves remain evanescent and that effectively NA=n₀′.

In FIG. 4 a measurement of the total amount of the reflected light for the polarisation states parallel and perpendicular to the polarisation state of the irradiating beam, and the sum of both is shown. The perpendicular polarisation state is suitable as an air-gap error signal for the near-field optical recording system.

In FIG. 5 is shown that the thickness variation of the cover layer may be larger or smaller than the focal depth.

In FIGS. 6A, 6B and 6C the principle of operation of a dual actuator in case of varying cover layer thickness is shown. In FIG. 6A the storage layer is in focus and the air gap is kept constant. In FIG. 6B the cover layer thickness varies, but still the air gap is kept constant by moving both lenses simultaneously. In FIG. 6C the first lens is displaced to regain focus on the storage layer. show the principle of operation of a dual actuator in case of varying disk-to-disk cover layer thickness,

In FIG. 7 a block diagram of the double servo system required to drive the dual lens actuator is shown. Two coupled servo loops are required:

One for the air gap, which makes the proximate surface of the optical objective follow the surface of the cover layer.

One for the focal length, which keeps the data layer within the focal depth by varying the focal length of the optical objective.

Note that the servo loops are dependent on each other. The servo bandwidths and the coupling constant are parameters to be determined for a practical solution.

A gap actuator (GA) is used for control of the air gap. This gap actuator is fitted with a smaller focus actuator (FA) that is used to control the focal position. Note that this smaller focus actuator may have a much smaller bandwidth than the larger gap actuator because it only needs to suppress cover layer thickness variations that are of the order of several microns. Furthermore the residual position error of the first lens is quite large because of the added magnification from the SIL that is kept at a constant distance to the disc. Thus a relatively large position error for the first lens results in a much smaller error in the focal position on the disc.

The focus actuator is driven by a PID controller (PID 1) with a conventional normalised (astigmatic or Foucault) focus error signal (FEN) as input. The normalised focus error signal is generated by divider 1 from a difference signal (ΔFES) and sum signal (ΣFES) from a set of photodiodes. A focus offset signal and focus pull-in procedure is fed into the controller by a central microprocessor (μProc). The gap actuator is driven by a second PID controller (PID 2), using a normalised gap error signal (GEN) as input. This normalised gap error signal is generated by a divider that divides the gap error signal (GES) by the focus sum signal (or a signal from a forward sense diode). A controller set point and air gap pull-in procedure is fed into the controller by the central microprocessor.

Two control signals are required:

The width of the air gap can be controlled using an error signal derived from the amount of evanescent coupling between SIL and cover layer. In FIG. 4 a typical gap error signal (GES) is shown

The focal length can be controlled using a conventional S-curve focus error signal (FES), see FIG. 8.

In FIG. 8 an example of a conventional S-curve type focus error signal (FES) is shown. In case of near-field optical recording such a signal can be obtained from the optical signal if the cover layer thickness h is much larger than the focal depth, h>>Δf.

In FIG. 9 a cross section of a possible embodiment of a dual lens actuator for near field is shown.

In FIG. 10 an optical data storage system for recording and/or reading, using a radiation beam, having a wavelength λ=405 nm is shown. The radiation beam is focused onto a data storage layer of an optical data storage medium. The system comprises:

the medium (substrate, storage layer and cover layer) having a cover layer that is transparent to the focused radiation beam,

an optical head, including an objective having a numerical aperture NA, said objective including a solid immersion lens (SIL) that is adapted for being present at a free working distance of smaller than λ/10 from an outermost surface of said medium and arranged on the cover layer side of said optical data storage medium. From said solid immersion lens the focused radiation beam is coupled by evanescent wave coupling into the cover layer of the optical data storage medium during recording/reading. The optical head comprises:

a first adjustable optical element (SIL) corresponding to the solid immersion lens,

means for axially moving the first optical element and dynamically keeping constant the distance between cover layer and solid immersion lens,

a second adjustable optical element (lens),

means for dynamically adjusting the second optical element for changing the focal position of the focal point of the focused radiation beam relative to an exit surface of the solid immersion lens. The second optical element is present in the objective. The second optical element (lens) is axially movable with respect to the first optical element, see FIG. 7 and FIG. 9.

In FIG. 11 is shown that defocus also can be obtained by moving the laser collimator lens with respect to the objective.

In FIG. 12 a switchable optical element based on electrowetting (EW) or liquid crystal (LC) material, that can be used to adjust the focal length of the optical system, is shown. It is also possible to simultaneously compensate for a certain amount of spherical aberration in this way. Hence the lens (second optical element) has a focal length which is electrically adjustable, e.g. by electrowetting or by electrically influencing the orientation of liquid crystal material.

In FIG. 13 a switchable optical element based on electrowetting or liquid crystal material can be used to adjust the focal length of the optical system is shown. Here the element is placed between the lens and the SIL. It is also possible to simultaneously compensate for a certain amount of spherical aberration in this way.

A dual lens actuator has been designed, see Refs. [6] which has a Lorentz motor to adjust the distance between the two lenses within the recorder objective. The lens assembly as a whole fits within the actuator. The dual lens actuator consists of two coils that are wound in opposite directions, and two radially magnetised magnets. The coils are wound around the objective lens holder and this holder is suspended in two leaf springs. A current through the coils in combination with the stray field of the two magnets will result in a vertical force that will move the first objective lens towards or away from the SIL. A near field design may look like the drawing in FIG. 9.

A first embodiments of an optical objective with variable focal position is shown in FIGS. 6 and 9, and it is repeated in FIG. 10. Alternative embodiments to change the focal position of the system comprise, for example, adjustment of the laser collimator lens, see FIG. 11, or a switchable optical element based on electrowetting or liquid crystal material, see FIGS. 12 and 13 and also Ref. [7]. These measures, of course, can be taken simultaneously.

### REFERENCES

[1] Ferry Zijp and Yourii V. Martynov, “Static tester for characterization of optical near-field coupling phenomena”, in Optical Storage and Information Processing, Proceedings of SPIE 4081, pp. 21-27 (2000).
[2] Kimihiro Saito, Tsutomu Ishimoto, Takao Kondo, Axiyoshi Nakaoki, Shin Masuhara, Motohiro Furuki and Masanobu Yamamoto, “Readout Method for Read Only Memory Signal and Air Gap Control Signal in a Near Field Optical Disc System”, Jpn. J. Appl. Phys. 41, pp. 1898-1902 (2002).
[3] Martin van der Mark and Gavin Phillips, “(Squeaky clean) Hydrophobic disk and objective”, (2002); see international patent application publication WO 2004/008444-A2 (PHNL0200666).
[4] Bob van Someren; Ferry Zijp; Hans van Kesteren and Martin van der Mark, “Hard coat protective thin cover layer stack media and system”, see international patent application publication 2004/008441-A2 (2002) (PHNL0200667).
[5] TeraStor Corporation, San Jose, Calif., USA, “Head including a heating element for reducing signal distortion in data storage systems”, U.S. Pat. No. 6,069,853.
[6] Y. V. Martynov, B. H. W. Hendriks, F. Zijp, J. Aarts, J.-P. Baartman, G. van Rosmalen J. J. H. B. Schleipen and H.van Houten, “High numerical aperture optical recording: Active tilt correction or thin-cover layer?”, Jpn. J. Appl. Phys. Vol. 38 (1999) pp. 1786-1792.
[7] B. J. Feenstra, S. Kuiper, S. Stallinga, B. H. W. Hendriks, R. M. Snoeren, “Variable focus lens”, see international patent application publication WO 2003/069380-A1. S. Stalling a, “Optical scanning device with a selective optical diaphragm”, U.S. Pat. No. 6,707,779 B1.

1. An optical data storage system for recording and/or reading, using a radiation beam, having a wavelength λ, focused onto a data storage layer of an optical data storage medium, said system comprising:
the medium having a cover layer that is transparent to the focused radiation beam,
an optical head, including an objective having a numerical aperture NA, said objective including a solid immersion lens that is adapted for being present at a free working distance of smaller than λ/10 from an outermost surface of said medium and arranged on the cover layer side of said optical data storage medium, and from which solid immersion lens the focused radiation beam is coupled by evanescent wave coupling into the cover layer of the optical data storage medium during recording/reading,
characterized in that,
the optical head comprises:
a first adjustable optical element corresponding to the solid immersion lens,
means for axially moving the first optical element and dynamically keeping constant the distance between cover layer and solid immersion lens,
a second adjustable optical element,
means for dynamically adjusting the second optical element for changing the focal position of the focal point of the focused radiation beam relative to an exit surface of the solid immersion lens.

2. An optical recording and reading system as claimed in claim 1, wherein the second optical element is present in the objective.

3. An optical recording and reading system as claimed in claim 1, wherein the second optical element is present outside the objective.

4. An optical recording and reading system as claimed in claim 2, wherein the second optical element is axially movable with respect to the first optical element.

5. An optical recording and reading system as claimed in claim 2, wherein the second optical element has a focal length which is electrically adjustable, e.g. by electrowetting or by electrically influencing the orientation of liquid crystal material.

6. A method of optical recording and/or reading with a system as claimed in claim 1, wherein:
the free working distance is kept constant by using a first, relatively high bandwidth servo loop based on a gap error signal, e.g. derived from the amount of evanescent coupling between the solid immersion lens and the cover layer,
the first optical element is actuated based on the first servo loop,
a second, relatively high bandwidth servo loop is active based on a focus control signal,
the second optical element is adjusted based on the second servo loop in order to retrieve an optimal modulated signal.

7. Method as claimed in claim 6, wherein the focus control signal is derived from the modulation depth of a modulated signal recorded in the data storage layer.

8. A method as claimed in claim 6, wherein the focus control signal is derived from an S-curve type focus error signal.

9. A method as claimed in claim 7, wherein an oscillation is superimposed on the adjustment of the second optical element and wherein the focus control signal additionally is derived from the oscillation direction of the second optical element.

10. A method as claimed in claim 7, wherein the modulated signal is present as pre-recorded data in the optical data storage medium.

11. A method as claimed in claim 7, wherein the modulated signal is present in a lead-in area of the optical data storage medium.

12. A method as claimed in claim 7, wherein the modulated signal is present as a wobbled track of the optical data storage medium.
